(19) United States
(12) Patent Application Publication
(10) Pub. No.: US 2024/0306203 A1
(43) Pub. Date: Sep. 12, 2024

(54) ADAPTIVE UPLINK TRANSMISSION IN AN UNLICENSED RADIO SPECTRUM

(71) Applicant: Sony Group Corporation, Tokyo (JP)

(72) Inventor: Rickard LJUNG, Helsingborg (SE)

(21) Appl. No.: 18/280,410

(22) PCT Filed: Feb. 14, 2022
(86) PCT No.: PCT/EP2022/053470

§ 371 Date: Sep. 5, 2023

(30) Foreign Application Priority Data
Mar. 22, 2021 (SE) 2150328-9

(51) Int. Cl. H04W 74/0816; H04L 27/26; H04W 74/00; H04W 74/08

(52) U.S. Cl. CPC H04W 74/0816; H04L 27/26025; H04W 74/004; H04W 74/0866

(57) ABSTRACT

A method carried out in a radio station for wireless transmission in an unlicensed radio spectrum, the method comprising: obtaining (402) identification of alternative configurations of radio parameters: determining (404) a specific configuration of said alternative configurations, based on a clear channel assessment requirement associated with an upcoming transmission of a signal; and transmitting (406) the signal using the specific configuration.

### TECHNICAL FIELD

This disclosure relates to solutions provided for uplink transmission in a wireless network within an unlicensed radio spectrum. Specifically, a solution is provided which allows for adaptive configuration of radio parameters in association with an uplink transmission, based on a clear channel assessment requirement.

### BACKGROUND

Traditionally, cellular radio network systems were designed to run over frequencies exclusively licensed to specific mobile operators. In non-cellular radio network systems, such as Wireless Local Area Network (WLAN) under IEEE standard 802.11, also referred to as Wi-Fi, several terminals may establish connection and exchange data with an access point without having to be registered to any operator. In addition, any WLAN may be set up to make use of any part of an unlicensed radio band. Since different WLANs can overlap, and often do, there will be a risk for collisions between data packets sent on a common channel. This is handled by algorithms for collision avoidance, such as CSMA/CA (Carrier Sense Multiple Access with Collision Avoidance), which are covered in the 802.11 specification.

Development of the framework and technical specifications used within 3GPP (3^{rd} Generation Partnership Project) has resulted in the provision of allowing communication of signals in a cellular radio network to be conveyed in unlicensed frequency bands. In such a scenario, a transmitting entity must therefore take existing traffic into consideration, so as not to cause collision or interference.

In 3GPP standards, a wireless station is referred to as a User Equipment (UE), a term that will be used consistently herein too. Although such a UE has traditionally been referred to as a mobile device, such as a mobile phone, it may in fact just as well be stationary. The wireless network comprises an access network, which comprises one or more base stations configured to communicate with UEs for data and control signaling.

In a wireless network, a UE operates in different states/modes. Typically there is one or more idle state, and there is one or more connected state. It may be easy to believe that the UE is constantly active with transmission and/or reception when in a connected state, and that the UE is never transmitting or receiving in an idle state. But in practice, there is almost always a mix of activity (transmissions and/or receptions) and inactivity (no transmission and/or reception) in any state-just with a difference in the activity vs non-activity ratios.

One aspect that needs to be considered is communication preparations and channel evaluations during periods with relatively large inactive time windows. 3GPP specifications allow, for example, pilot transmissions in both the uplink (UL) and downlink (DL) direction, such as sounding reference signals (SRS) and various types of reference signals and sync signals. These types of signals may be transmitted e.g. when a UE is in an active state even if there is no data transmission ongoing at that moment. Also, there may be other types of control signaling used to keep the communication link ready for more data transmissions. Such control signaling may be e.g. an active mode data scheduling indicator (“connected mode wake up signal”), channel measurements reporting or similar.

When operating in an unlicensed spectrum or frequency band, herein called band for short, there may be requirements to perform a so-called clear channel assessment (CCA) prior to the transmission on the channel, to appraise the RF medium for the purpose of determining whether the medium is busy before transmitting. In other words, the medium must be clear before the UE can transmit. This may involve listening for RF transmissions at the physical layer, and making assessments based on detected energy with reference to one or more thresholds. The more traffic present on the medium, the longer the assessment procedure may take and the longer the transmission may need to be postponed.

### SUMMARY

A general objective is to provide a procedure which is suitable for implementation in the preparation for signal transmission in an unlicensed spectrum. A solution proposed herein is defined by the terms of the independent claims, whereas advantageous examples are set out in the dependent claims.

According to one aspect, a method carried out in a radio station for wireless transmission in an unlicensed radio spectrum is provided. The method comprises:
obtaining identification of alternative configurations of radio parameters;
determining a specific configuration of said alternative configurations, based on a clear channel assessment requirement associated with an upcoming transmission of a signal; and
transmitting the signal using the specific configuration.

The solution is based on the notion that dependent on the character of a signal to transmit, such as the signal transmission being short enough in time, certain signals may be allowed to be transmitted with use of no CCA or a very short or simple CCA. The proposed solution is therefore to set up alternative configurations of radio parameter, such that a signal may be transmitted with a CCA procedure which is beneficial to the radio station.

Further aspects and advantages associated with the proposed solution are set out in the following description.

### BRIEF DESCRIPTION OF THE DRAWINGS

The proposed solution is described in more detail below with reference to the accompanying drawings, in which various examples of realizing the solutions are outlined.

FIG. 1 schematically illustrates a wireless network according to some examples, in which the proposed solutions may be set out.

FIG. 2 schematically illustrates a UE configured to operate in accordance with the examples laid out herein.

FIG. 3 schematically illustrates a base station configured to operate in accordance with the examples laid out herein.

FIG. 4 is a flowchart schematically illustrating various steps carried out in a radio station according to certain examples of the proposed solution.

FIG. 5 schematically illustrates the implementation of an example of the proposed solution and its effect on the transmission of a signal by the radio station.

### DETAILED DESCRIPTION

In the following description, for purposes of explanation and not limitation, details are set forth herein related to various examples. However, it will be apparent to those skilled in the art that the present disclosure may be practiced in other examples that depart from these specific details. In some instances, detailed descriptions of well-known devices, circuits, and methods are omitted so as not to obscure the description of the present disclosure with unnecessary detail. The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented and are thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) (ASIC), and (where appropriate) state machines capable of performing such functions. In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

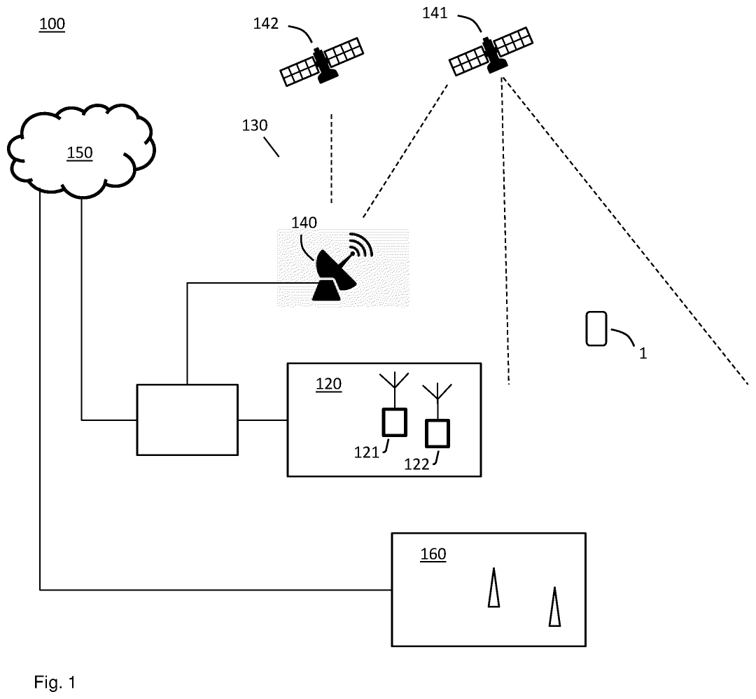

FIG. 1 schematically illustrates a wireless communication scenario, providing an example of a scene in which the solutions provided herein may be incorporated for preparing for signal transmission. The wireless communication system includes a wireless network 100, and a UE (or wireless device) 1 configured to wirelessly communicate with the wireless network 100. The wireless network 100 comprises a core network 110, which is connected to other communication networks 150. The wireless network 100 further comprises one or more access networks 120, 130, usable for communication with UEs of the system. Such access networks may comprise a terrestrial network 120 comprising a plurality of access nodes or base stations 121, 122, configured to provide a wireless interface for, inter alia, the UE 1. The base stations 121, 122 may be stationary or mobile. Each base station, such as the terrestrial base station 121, 122, comprises a point of transmission and reception, referred to as a Transmission and Reception Point (TRP), which coincides with an antenna of the respective base station. Logic for operating the base station may be configured at the TRP or at another physical location. The access network may further comprise a non-terrestrial network (NTN) 130. The NTN 130 may comprise one or more satellites 141, 142, operating as NTN base stations and configured to transmit signals associated with a cell of the wireless network 100. A ground station 140 of the NTN 130 may be connected to the core network 110, and wirelessly connected to one or more of the satellites 141, 142. Each satellite 141, 142 may be seen as one NTN TRP for the respective NTN base station or access node, realizing an NTN cell, whereas logic and hardware for each such non-terrestrial network base station may be completely or partly configured in the ground station 140 or in other nodes of the access network.

The wireless network 100 is configured to communicate, i.e. transmit and/or receive signals, with the UE 1 in at least an unlicensed band, by means of one or more of the base stations, 121, 122, 141, 142. In some examples the access network 120 is a so called 5G network access node 121, 122, e.g. a New Radio (NR) network, in which the base station typically is referred to as a gNB. The UE 1 may be any device operable to wirelessly communicate with the network 100 through the base stations 121, 122, such as a mobile telephone, computer, tablet, a machine to machine (M2M) device, an IoT (Internet of Things) device or other. FIG. 1 further indicates other systems 160 available to the UE 1 for communication in the unlicensed spectrum, such as a Wi-fi 802.11 system.

Before discussing various process solutions for the proposed method, the UE 1 and a base station 300, such as one of base stations 121, 122, 141, 142, will be functionally discussed on a general level.

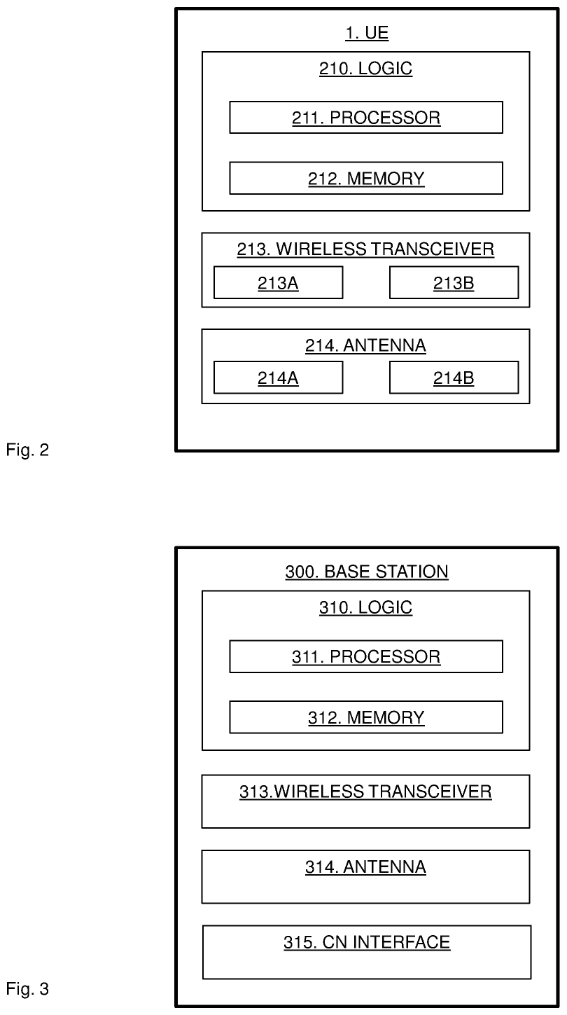

FIG. 2 schematically illustrates an example of the UE 1 for use in a wireless network 100 as presented herein, and for carrying out the method steps as outlined. The UE 1 may be a New Radio (NR) UE in which the UE may be connected to a 5G NR cellular access network 120.

The UE 1 comprises a radio transceiver 213 for communicating with other entities of the radio communication network 100, such as the base stations 121, 122 and other nodes 150, in various frequency bands. The transceiver 213 may thus include a radio receiver and transmitter for communicating through at least an air interface. The UE1 may comprise a transceiver 213A for communication with one or more of the access networks 120, 130 and a transceiver 213B for Wi-Fi communication.

The UE 1 further comprises logic 210 configured to communicate data, via the radio transceiver 213, on a radio channel, to the wireless communication network 100 and possibly directly with another terminal by Device-to Device (D2D) communication.

The logic 210 may include a processing device 211, including one or multiple processors, microprocessors, data processors, co-processors, and/or some other type of component that interprets and/or executes instructions and/or data. The processing device 211 may be implemented as hardware (e.g., a microprocessor, etc.) or a combination of hardware and software (e.g., a system-on-chip (SoC), an application-specific integrated circuit (ASIC), etc.). The processing device 211 may be configured to perform one or multiple operations based on an operating system and/or various applications or programs.

The logic 210 may further include memory storage 212, which may include one or multiple memories and/or one or multiple other types of storage media. For example, the memory storage 212 may include a random access memory (RAM), a dynamic random access memory (DRAM), a cache, a read only memory (ROM), a programmable read only memory (PROM), flash memory, and/or some other type of memory. The memory storage 212 may include a hard disk (e.g., a magnetic disk, an optical disk, a magneto-optic disk, a solid state disk, etc.). The memory storage 212 is configured for holding computer program code, which may be executed by the processing device 211, wherein the logic 210 is configured to control the UE 1 to carry out any of the method steps as provided herein. Software defined by said computer program code may include an application or a program that provides a function and/or a process. The software may include device firmware, an operating system (OS), or a variety of applications that may execute in the logic 210.

The UE 1 may further comprise an antenna system 214, which may include one or more antenna arrays. In various examples the antenna system 214 comprises different antenna elements configured to communicate with the wireless network 100, and optionally also antenna devices for communication with other nodes 150, and e.g. for reception of GNSS signals. As an example, the antenna system 214 may comprise one or more of an antenna 214A for communication with the access network 120, and an antenna 214B for Wi-Fi communication.

Obviously, the UE 1 may include other features and elements than those shown in the drawing or described herein, such as a power supply, a casing, a user interface, further sensors, etc., but are left out for the sake of simplicity.

FIG. 3 schematically illustrates an example of a base station 300, such as a cellular base station 120 or 141 configured to operate in an unlicensed band.

The base station 300 comprises logic 310 configured to control wireless communication with UEs, and communication with the core network 110. The logic 310 may include a processing device 311, including one or multiple processors, microprocessors, data processors, co-processors, and/or some other type of component that interprets and/or executes instructions and/or data. The processing device 311 may be implemented as hardware (e.g., a microprocessor, etc.) or a combination of hardware and software (e.g., a system-on-chip (SoC), an application-specific integrated circuit (ASIC), etc.). The processing device 311 may be configured to perform one or multiple operations based on an operating system and/or various applications or programs.

The logic 310 may further include memory storage 312, which may include one or multiple memories and/or one or multiple other types of storage mediums. For example, the memory storage 312 may include a random access memory (RAM), a dynamic random access memory (DRAM), a cache, a read only memory (ROM), a programmable read only memory (PROM), flash memory, and/or some other type of memory. The memory storage 312 may include a hard disk (e.g., a magnetic disk, an optical disk, a magneto-optic disk, a solid state disk, etc.). The memory storage 312 is configured for holding computer program code, which may be executed by the processing device 311, wherein the logic 310 is configured to control the base station 300 to carry out any of the method steps as provided herein. Software defined by said computer program code may include an application or a program that provides a function and/or a process. The software may include device firmware, an operating system (OS), or a variety of applications that may execute in the logic 310.

The base station further comprises a radio transceiver 313 for communicating radio signals with UEs in various frequency bands, including unlicensed bands. The transceiver 313 may thus include a radio receiver and transmitter for communicating through at least an air interface.

The base station 300 may further comprise, or alternatively be connected to, an antenna system 314, which may include one or more antenna arrays. The antenna system 314 is operable by means of the transceiver 313 to communicate with UEs.

The base station 300 further comprises a communication interface 315 for connection to the other nodes of the wireless network 100, such as the core network (CN) 110.

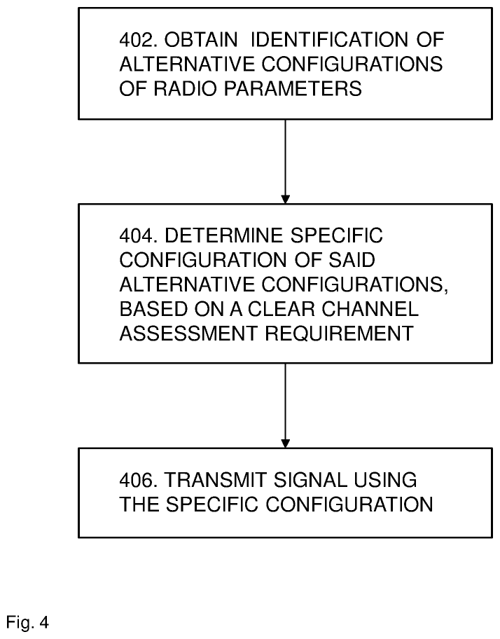

FIG. 4 shows a flowchart of the proposed solution, which involves adding a methodology and functionality for transmission of a signal, and configuration of the radio device for the transmission, from a radio station in an unlicensed band. Specifically, the proposed solution allows for configuration of signal transmission, determined by the radio station, for easier clear channel assessment on an unlicensed band. The signal may be a control signal in a cellular radio network 100.

As channel access regulations may differ, e.g. based on spectrum range and/or geographic location (world region), the usage of different types of CCA procedures may vary. Nevertheless, the principal scenario on which the proposed solution is based is that the radio device is allowed to transmit on a radio channel after performing CCA. Or, differently put: the radio device is obliged to adhere to a clear channel assessment requirement, imposed by regulations such as technical specifications or legal requirements, before transmitting a signal. The clear channel assessment requirement may in various cases be different dependent on the type or content of the signal to transmit.

In various scenarios, regulations for the channel assessment requirement may prescribe that if there is a gap in the transmission, from the radio device in the unlicensed band, the radio device may be allowed to transmit again after that gap. For the sake of simplicity and ease of understanding, the gap in the transmission may be said to separate a first transmission from a second, later, transmission. However, the regulations on what CCA to perform prior to such second transmission after the gap may differ depending on inter alia the gap length and on the transmission length of the second transmission. It may be noted that the content and character of the second transmission need not be similar to or even dependent on the first transmission. In other words, the first transmission may e.g. be a data transmission, whereas the second transmission is a control signal transmission. Herein, transmission of a signal refers to the mentioned second transmission.

In certain examples, the radio station is the UE 1, configured to transmit the signal to the wireless network 100, such as to a base station 300, e.g. the base station 121. The signal may e.g. be an UL control signal. In other examples, the radio station is a base station 120 of the wireless network 100, configured to transmit the signal in the DL to the UE 1.

With reference to FIG. 4, the proposed solution provides the following process steps and features.

In step 402, the radio station obtains identification of alternative configurations of radio parameters.

In step 404, the radio station determines a specific configuration of said alternative configurations, based on a clear channel assessment requirement associated with an upcoming transmission of a signal.

In step 406, the radio station transmits the signal using the specific configuration.

The proposed solution provides the technical effect of the radio station being allowed or configured to adaptively use one of a plurality of configurations of radio parameters for transmission of the signal, for the purpose of identifying a certain CCA procedure to abide by. This provides a degree of freedom for the transmission of the signal, such that advantages associated with a certain CCA procedure can be obtained, based on the scenario or context of the radio station.

The obtainment 402 may comprise obtaining a main configuration and one or more additional configurations, or a number of different alternative configurations of radio parameters. The radio station may be configured to determine between the configurations, e.g. based on a gap length between transmissions. Such gap length between transmissions may refer to a gap between transmissions by the same device or a gap between transmissions by two different devices. The gap length may be determined by measurements performed by one or more devices, or by information in signaling provided between devices.

Where the radio station is the UE 1, identification of one or more of the alternative configurations, such as only a main configuration, may be obtained as system information from the wireless network 100, or alternatively by dedicated signaling to the UE 1, or to a group of UEs including the UE 1. In various examples, the alternative configurations are obtained by reception of an identifier, wirelessly conveyed from the wireless network 100 to the UE 1, which identifier is mapped in the UE 1 to identify the various radio parameters for the alternative configurations. In some examples, the alternative configurations are differentiated by including different values of one or more radio parameter. In some examples, one of the alternative configurations may be seen as a modification of another one of the alternative configuration, obtained by changing one or more of the radio parameters, e.g. temporarily.

In some examples, the radio parameter configuration may be signaled as part of a dedicated signaling such as a downlink control information (DCI) to the UE 1. Several DCI formats exist where radio configurations for upcoming transmissions may be adjusted. Other methods for providing an alternative radio parameter configuration may be envisioned, e.g. as a general rule indicated for a cell in a broadcasted signaling, or a part of RRC signaling (Layer 2-3). Adjustment may be carried by on physical layer signaling, and may be specified for physical channels and modulation, or for physical layer procedures for control.

Functionality wise, the usage of the alternative configuration may be conditioned to specific types of transmissions, such as uplink sounding reference signaling transmissions (SRS) or hybrid ARQ transmissions. As one alternative, the specifications may imply that if a transmission includes a certain information, the radio configuration should be changed, to fit into the suitable time of transmission.

The radio station is in some examples configured to determine the specific configuration, selected or identified among the alternative configurations, as the configuration which offers a preferred clear channel assessment procedure among the alternative configurations. This way, dependent on the scenario and context, the radio station may determine the specific configuration which e.g. provides least energy consumption, shortest expected postponement of the signal transmission, or the best chances of the signal reaching an addressed receiver station. One example of a preferred clear channel assessment procedure may to transmit without channel sensing.

In some examples, the specific configuration is determined as the configuration offering a shortest clear channel assessment period among the alternative configurations. The total time required under a certain CCA procedure, i.e. the time until signal transmission can be obtained, may not be known to the radio station beforehand, as it is dependent on contention with communication by other stations at the time of commencing the CCA procedure.

In some examples, the determination of the shortest clear channel assessment period is carried out based on a last transmission by the radio station, where a CCA procedure was used. That last transmission may have comprised a certain amount of channel sensing, or attempted but postponed transmission, that provides an estimate of the load or traffic on the medium during that last CCA procedure. By relying on that similar conditions on the radio medium exist as during that last CCA procedure, a configuration of radio parameters which provides for a certain CCA procedure can thereby be determined. This can be seen as a way of obtaining an estimate of the medium. In some examples, the determination of the CCA procedure to use is only based on the last used CCA procedure responsive to a time period since the last CCA procedure not exceeding a time threshold. In some examples the determination of the CCA procedure to use concludes that the transmission is to be made without applying a CCA but instead transmit without sensing. In some examples the transmission without sensing may be applied if the gap length is shorter than a threshold, and/or if the resulting transmission length is shorter than a threshold, and/or is shorter than a threshold and includes a specific type of content and/or does not include a specific type of content.

In other examples, an average time for a certain CCA procedure is known, calculated, or obtained from the wireless network 100, by the radio station. The average time may e.g. be based on probability factors calculated based on statistics of historically used CCA procedures before signal transmissions, by the same radio station or a plurality of radio stations. In some examples, the average time for a certain CCA procedure may be dependent on a type of the signal to transmit by the radio station. In some examples, the average time for a certain CCA procedure may be dependent on a context of the radio station, such as location and/or time of day. By comparing determined average time for different configurations, the specific configuration may be identified as providing the shortest average time, thereby identifying the shortest clear channel assessment period.

In some examples, the specific configuration is applied which offers a shortest listen before talk (LBT) period such as e.g. determined by the length of one or more sensing gaps during the CCA of the clear channel assessment period. In accordance with the examples given above, the LBT period for different CCA procedures may e.g. be determined based on a last transmission by the radio station, and/or on average LBT periods for applied configurations of radio parameters.

In some examples, the alternative configurations comprise at least a first configuration and a second configuration, of which the second configuration provides for shorter transmission time of the signal. By adaptively using the second configuration, thereby allowing a shorter transmission time of the signal, CCA requirement may allow for a shorter CCA period, such as a shorter LBT period. In some examples, the radio station is configured to identify the specific configuration as the second configuration responsive to the shorter transmission time actually providing a shorter CCA period than using the first configuration.

In some examples, the alternative configurations of radio parameters identify different subcarrier spacing. This may be applicable in radio communication systems operating on very high carrier frequencies, e.g. 50 GHz or higher, where a wide range of subcarrier spacings may be defined. Different subcarrier spacing may be defined for different parts of the unlicensed spectrum for use in such a system. Alternatively, or additionally, different subcarrier spacing may be applied in different time periods. In some examples, by configuring the radio parameters to a higher OFDM (Orthogonal Frequency Division Multiplex) subcarrier spacing for the upcoming transmission, a shorter transmission time of the signal may thus be obtained, which allows for, or prescribes, a shorter or simpler CCA procedure. The result may be faster/earlier transmission of the signal.

In some examples, the alternative configurations of radio parameters identify different modulation schemes and/or transmit powers. For example, the process may comprise allowing the radio device to temporarily adjust radio parameters such as modulation scheme, transmission power etc., to accommodate a certain control signaling payload to be transmitted over the channel on a shorter time period. The result may be earlier transmission of the signal.

In some examples, the process step of determining the specific configuration of radio parameters to use for the upcoming signal transmission is carried out based on the signal being a predetermined type of signal. The radio device may in some examples be configured to select a certain configuration dependent on the type of the signal. In other examples, the radio station may be configured to make a determination of the specific configuration only on the condition that the upcoming transmission includes a certain type of signal, i.e. responsive to the signal being of a certain type. Examples of signals based on which configuration of radio parameters to use for the upcoming signal transmission may be carried out may include sounding reference signal (SRS), one or more control signal types, measurement info, UCI (Uplink Control Information) or DCI (Downlink Control information), a data (payload) carrying signal, an acknowledgement signal (ACK/NACK), a resource allocation signal etc.

In some examples, the process step of determining the specific configuration of radio parameters to use for the upcoming signal transmission is carried out based on content to be conveyed in the signal. In this context, the radio device may in some examples be configured to select a certain configuration dependent on the type and/or size of the content. In other examples, the radio station may be configured to make a determination of the specific configuration only on the condition that the upcoming transmission includes content of a certain type and/or size. The type of the content, to be included as payload in the signal, may e.g. be associated with a certain latency requirement, or a certain priority, based on which the determination of the specific configuration of radio parameters is made.

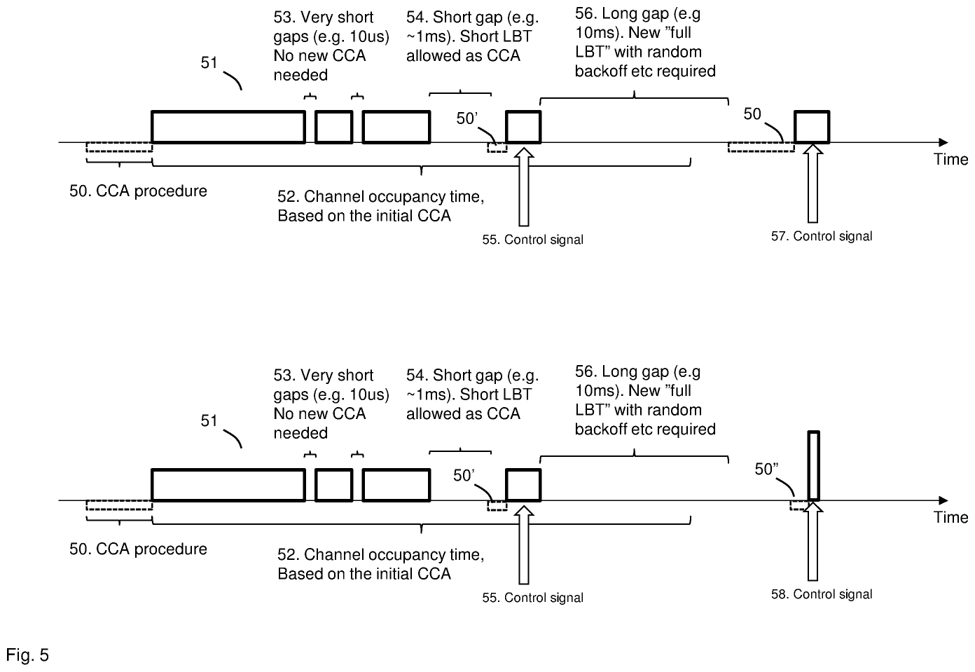

FIG. 5 schematically illustrates signaling by a radio station according to legacy behavior at the top, and according to an example of the proposed solution at the bottom. As noted, the proposed solution provides a methodology for allowing the transmitting radio device to adjust its configuration of radio parameters. In the example of FIG. 5, this involves conditionally determining a specific configuration which modifies the expected transmission time of a signal, responsive to the radio device being able to access the channel with a different CCA procedure due to the transmission time modification. As noted, modification of the transmission time may be accomplished by adjusting the OFDM subcarrier spacing for the upcoming transmission, or e.g. allowing the transmitting radio device to temporarily adjust radio parameters such as modulation scheme, transmission power etc., to accommodate a certain control signaling payload to be transmitted over the channel on a shorter time period.

The example of FIG. 5 identifies an initial CCA procedure 50, prior to a first transmission 51. The initial CCA procedure may be associated with a certain channel occupancy time 52. As outlined above, very short gaps 53, below a certain time threshold such as 10 μs, may be allowed for the transmitting radio station without requiring a new CCA procedure to be carried out. Even slightly longer gaps, here referred to as short gaps 54, may be allowed with a shorter CCA period 50′, such as shorter LBT period. A short gap threshold may be defined for allowing the shorter CCA period 50′, such as for gaps smaller than 1 ms.

When a longer gap 56 occurs after a first transmission and before a subsequent transmission 57, such as longer than the short gap threshold, regulations may prescribe that for a transmission using a main configuration of radio parameters, or using the same configuration of radio parameters as for the preceding transmission 51, a full CCA procedure 50 must be carried out. This is indicated in the top part of FIG. 5.

However, according to the proposed solution, the radio device is configured to adaptively determine configuration of radio parameters for use in an upcoming transmission, so as to accommodate to a different CCA requirement. This is illustrated in the bottom part of FIG. 5. Here, the radio device applies a different or modified configuration of radio parameters, so as to accomplish a shorter transmission time of the upcoming transmission 58 (the transmission 58 being indicated as higher to schematically represent that the same content data is transmitted as in the signal 57, but in a shorter time). Based on the shortened transmission time, a shorter CCA period 50″ can be used under the CCA regulations at hand. This results in the technical effect of a higher likelihood of succeeding with completion of the transmission of the signal 58 within a certain period of time. As exemplified above, the determining of a specific configuration, by selection or modification of radio parameters, may be allowed and/or carried out conditionally based on one or more of the length of the gap 56, content of the signal 58, or type of the signal 58.

1. A method carried out in a radio station for wireless transmission in an unlicensed radio spectrum, the method comprising:
obtaining identification of alternative configurations of radio parameters;
determining a specific configuration of said alternative configurations, based on a clear channel assessment requirement associated with an upcoming transmission of a signal; and
transmitting the signal using the specific configuration.

2. The method of claim 1, wherein the specific configuration is determined as the configuration offering a shortest clear channel assessment period among the alternative configurations.

3. The method of claim 2, wherein the specific configuration offers a shortest listen before talk period.

4. The method of claim 1, wherein the specific configuration is determined as the configuration offering a preferred clear channel assessment procedure among the alternative configurations.

5. The method of claim 1, wherein the alternative configurations comprises a first configuration and a second configuration, of which the second configuration provides for shorter transmission time of the signal.

6. The method of claim 5, wherein the determining identifies the specific configuration as the second configuration responsive to the shorter transmission time providing a shorter clear channel assessment period than using the first configuration.

7. The method of claim 1, wherein the determining is carried out based on the signal being a predetermined type of signal.

8. The method of claim 1, wherein the determining is carried out based on content to be conveyed in the signal.

9. The method of claim 1, wherein the alternative configurations of radio parameters identify different subcarrier spacing.

10. The method of claim 1, wherein the determining is carried out based on a transmission gap preceding transmission of the signal.

11. The method of claim 1, wherein the alternative configurations of radio parameters identify different modulation schemes and/or transmit powers.

12. The method of claim 1, wherein the radio station is a wireless User Equipment (UE), configured to transmit the signal to a cellular wireless network.

13. The method of claim 12, wherein the signal is an uplink control signal.

14. The method of claim 1, wherein the radio station is a base station of a cellular wireless network, configured to transmit the signal to a User Equipment (UE).

15. A radio station adapted for wireless transmission in an unlicensed radio spectrum, the radio station comprising:
a radio transceiver;
logic configured to:
obtain identification of alternative configurations of radio parameters;
determine a specific configuration of said alternative configurations, based on a clear channel assessment requirement associated with an upcoming transmission of a signal; and
control the transceiver to transmit the signal using the specific configuration.

16. (canceled)
